(19) United States
(12) Patent Application Publication
(10) Pub. No.: US 2006/0064325 A1
(43) Pub. Date: Mar. 23, 2006

(54) Health management system, activity status measusring device, and data processing device

(75) Inventors: Masayo Matsumoto, Nagoya-shi (JP); Koji Ota, Nagoya-shi (JP); Yukihiko Ogihara, Nagoya-shi (JP); Kikuto Tanaka, Nagoya-shi (JP); Masateru Yoshida, Nagoya-shi (JP); Yoshiro Moriguchi, Nagoya-shi (JP)

Correspondence Address: OLIFF & BERRIDGE, PLC, P.O. BOX 19928, ALEXANDRIA, VA, 22320, US

(73) Assignee: Suzuken Co., Ltd, Nagoya-ashi (JP)

(21) Appl. No.: 10/529,943

(22) PCT Filed: Sep. 30, 2003
(86) PCT No.: PCT/JP03/12467

§ 371 Date: Apr. 1, 2005

(30) Foreign Application Priority Data
Oct. 2, 2002 (JP) 2002290517

(51) Int. Cl. G06F 19/00

(52) U.S. Cl. 705/3; 600/534

(57) ABSTRACT

So that health management advice is effective, the present invention effectively processes data that was obtained using a measuring device, and presents useful information for health management.

For this purpose, a measuring device 10 measures movement of a subject using an acceleration sensor 104, stores activity data in a storage part 114, stores identification information specifying the subject in an identification information storage part 118, and transmits the stored activity data and the identification information to a data processing device 20. A medical examination result database 30 is connected with the data processing device 20, and medical examination result data history is correlated with the identification information of the subject and is stored. The data processing device 20 is connected with the measuring device 10 for mutual communication, receives the activity data, and outputs a health management report produced on the basis of the activity data and on the basis of the medical examination result data history in the medical examination result database, this having been specified by the identification information.

### TECHNICAL FIELD

The present invention relates to a health management system, an activity status measuring device, and a data processing device.

### BACKGROUND ART

It is desirable to introduce adequate exercise into one's daily life so as to maintain good health. In particular, maintaining exercise over a long term is effective in the prevention and treatment of lifestyle diseases, such as diabetes. It is thus important that an exercise routine is incorporated into daily life.

For the prevention and treatment of diabetes, health management centers of the medical institutions have advised adequate exercise. A subject who receives health management advice carries a measuring device, and the measuring device measures his daily activity. The data obtained by the measuring device is brought to the health management center, which analyzes this data and gives advice to the subject (e.g., Japanese Laid-Open Patent Publication No. 10-295651).

For health management advice to be effective, it is important that the data obtained by this measuring device is effectively processed and that the processed data provides useful information for health management. However, in the technique set forth in the aforementioned patent, the data obtained by the measuring device was not effectively processed, nor did it provide useful information for health management.

Accordingly, it is an object of the health management system, measuring device and data processing device of the present invention to provide useful information for health management.

### DISCLOSURE OF INVENTION

In order to achieve the above object, the health management system of the present invention outputs a health management report which has been produced on the basis of activity of a subject having been measured by a measuring device, and on the basis of a medical examination result of the subject. In order to give effective health management advice, it is important to know the extent to which the subject's health (e.g., weight, blood glucose values) has been improved by means of exercise.

Specifically, the health management system of the present invention comprises a measuring device carried by the subject, which measures activity of the subject, a medical examination result database which stores medical examination result data history of the subject, and a data processing device, which is connected with the measuring device for mutual communication, processes activity data obtained by the measuring device.

The measuring device of the present health management system is carried by the subject and measures the subject's activity. For example, the measuring device measures the movement of the subject by using a physical movement measuring means such as an acceleration sensor. The measuring device determines the intensity of activity of a subject from the measured movement, and stores activity data which shows this intensity of activity. The measuring device also stores identification information which specifies the subject. The stored activity data and the identification information are then transmitted to the data processing device.

Moreover, the medical examination result database of the present health management system is connected with the data processing device for mutual communication, and stores the medical examination result data history of the subject which is correlated with the subject's identification information. The medical examination result database is provided, for example, in a medical institution.

The data processing device of the present health management system is connected with the measuring device for mutual communication, and processes the activity data which was obtained by the measuring device, and outputs useful information for health management. For this purpose, the data processing device comprises receiving means to receive the activity data and the identification information transmitted from the transmitting means of the measuring device. This identification information is correlated with the examination result data history. Thus, the data processing device extracts the examination result data history from the medical examination result database. Then the data processing device outputs a health management report which has been produced on the basis of the received activity data and on the basis of the extracted medical examination result data history.

In the present health management system, a health management report is displayed, which has been produced on the basis of the activity data and on the basis of the medical examination result data history. It is thus possible to present useful and easily grasped information concerning the subject's health, and it is easier to give effective health management advice.

In this health management system, it is preferred that the transmitting means of the measuring device transits activity data which has been stored within a predetermined period, and that the health management report output by the data processing device includes: states of activity within the predetermined period, these states of activity having been calculated from the activity data, and medical examination result data from before and after the predetermined period.

The measuring device was being carried during the predetermined period and the activity data was obtained. The states of activity within the predetermined period can be calculated from the obtained activity data. By means of these states of activity, changes in the medical examination results of the subject, such as weight, blood glucose values, are made apparent. The effects of health management can thus be grasped easily.

In this health management system, it is preferred that weight data of the subject is stored in the medical examination result data. In this case, it is preferred that the weight data from before and after the predetermined period is included in the medical examination result data in the health management report.

Alternatively, it is preferred that height data of the subject is also stored in the medical examination result data in addition to the weight data. In this case, it is preferred that the health management report further includes a graph of weight and height, one of these weight and height being on a vertical axis and the other on a horizontal axis. This graph shows a boundary between an upper limit and a lower limit of normal weight range, this range having been set on the basis of the height data of the subject.

Graphing the medical examination result data history makes it easy to visually recognize the effects of health management. The health management is thus effectively supported.

In this health management system, it is preferred that the identification information stored in the identification information storing means of the measuring device includes information for specifying a group to which the subject belongs, and that the medical examination result data history of each subject belonging to the group is stored in the medical examination result database. In this case, it is preferred that the health management report output by the data processing device further includes an average value of the medical examination result data of the group which is specified from the identification information.

The group consists of a plurality of subjects grouped together by a determined category (such as, for example, a class of diabetes in a community or workplace, or a private group). The medical examination result database stores the data history of each subject belonging to the group. This makes it possible to process the data history in various ways in which the group is treated as a unit. For example, it is possible to extract only the data of subjects belonging to a determined group, and to calculate the average value of the data of each group, and to compare the average values between groups. If each of the groups is receiving health management advice, this information may act as an incentive to members of the group.

In this health management system, it is preferred that the data processing device further includes means for inputting identification information for specifying the subject, and means for transmitting the input identification information to the measuring device. Further, it is preferred that the measuring device also includes means for receiving the transmitted identification information, and means for replacing the identification information, which is stored in the identification information storing means, with this received identification information.

In this case, it is preferred that the received identification information replaces the identification information, which is stored in the identification information storing means of the measuring device, only when the identification information receiving means has received the identification information from the data processing device.

The identification information is input by means of the data processing device. The identification information is replaced only when the measuring device receives the identification information from this data processing device. It is thus possible to prevent the identification information being altered accidentally in the measuring device. This ensures the reliability of the data, and allows more effective health management information to be presented.

In this health management system, it is preferred that the measuring device further comprises a first timer and means for producing a calendar date based on the time kept by the first timer. Moreover, it is preferred that the data processing device further comprises a second timer, means for producing calendar data for correction, this calendar data being based on the time kept by the second timer, and means for transmitting the calendar data for correction to the measuring device. Furthermore, it is preferred that the measuring device further includes means for receiving the calendar data for correction and means for correcting the first timer on the basis of the received calendar data for correction. The calendar data for correction, which is produced by the data processing device, can be set to be the standard. This enables the timers of a plurality of measuring devices to be corrected. It is thus possible to uniformly maintain the accuracy of the timer of each measuring device when one data processing device processes the activity data obtained by a plurality of measuring devices.

In this case, it is preferred that the measuring device further comprises means for inserting calendar data, which have been produced within each first predetermined period (e.g., a space of 4 seconds), into the activity data in the activity data storing means. The activity data has been produced within each second predetermined period (e.g., a space of 1 minute) and is stored in the activity data storing means. It also preferred that the measuring device has means for correcting the activity data stored in the activity data storing means. The correction is performed on the basis of a period for producing activity data specified from the calendar data inserted into the activity data. Thereupon, it is preferred that the activity data correcting means performs the following: (1) in the case where a plurality of items of activity data are stored from overlapping periods for producing activity data, any one of these plurality of items of activity data is retained and the other items are deleted, and (2) in the case where the activity data has a blank period in which no activity data has been produced, dummy data is inserted into the blank period.

A time difference with the timer of the measuring device may cause either an overlap or a blank period in the activity data produced within the first predetermined period. The calendar data functions as a key and the discrepancy in the data is deleted. The data can thus be made more reliable, and a more effective health management report can thus be produced.

Further, this data processing device produces a health management report presenting the activity data which is easily used to give advice, this activity data having been obtained by the measuring device. In order to manage subject's health appropriately by carrying out exercise, it is necessary to give advice based on activity data which was obtained over a long period (e.g., a period of 1 month or longer). When the subject's state of activity over a long period is presented and the presented state is easily used to give advice by the health management advisor, useful information for health management can be provided.

Specifically, in one aspect of a second data processing device of the present invention, the second data processing device comprises means for receiving the activity data transmitted from the measuring device, and means for outputting a health management report including states of activity calculated from the received activity data.

A period in which the received activity data was obtained (e.g., 1 week) is divided into a plurality of first predetermined periods (e.g., 1 day). The health management report output by the second data processing device includes a graph displaying, for each first predetermined period, total of time. This total of time has been obtained from the activity data for the case where intensity of activity was above a predetermined value during the first predetermined period. In the health management report, the total(s) of time within a plurality of first predetermined periods, which has exceeded the predetermined total of time, is(are) indicated with a marker.

The total(s) of time is(are) displayed which has(have) been obtained from the activity data for the case where intensity of activity was above the predetermined value during the first predetermined period. The total(s) of time is(are) marked in which the predetermined total of time has been exceeded. It is thus possible to easily recognize visually whether suitable exercise has been performed.

Further, it is preferred that the totals of time of the first predetermined periods are displayed in one graph. The display is given using long-term period units longer than the first predetermined periods. This makes it possible to ascertain whether exercise for health management has been adopted as a routine.

Furthermore, the second data processing device further includes a display for displaying the health management report; means for selecting one of the totals of time displayed in the display, and means for displaying changes over time in the display after one the totals of time has been selected by using the selecting means. These changes over time in the activity data has been obtained within the first predetermined period of the selected total of time.

The changes over time in the activity data are displayed in connection with the display of the total of time of the first predetermined period. This makes it easy to recognize visually the subject's states of activity, across time, within the first predetermined period.

In another aspect of the second data processing device, the health management report may include a graph. The period in which the received activity data was obtained (e.g., 1 week) is divided into a plurality of second predetermined periods (e.g., 1 day), and the health management report includes a graph displaying, for each second predetermined period, the energy consumption by exercise or the number of steps, these having been calculated from the activity data obtained within the second predetermined period. It is preferred that a predetermined value set for the energy consumption or the number of steps functions as a boundary and that background colors of the graph differ on one side and the other side of the boundary.

In this case, it is preferred that the predetermined value is an average value of the energy consumption or the number of steps, and the average value has been calculated for each second predetermined period. Alternatively, it is preferred that the predetermined value is a target value for the energy consumption that should be expended or the number of steps that should be expended within the second predetermined period.

Background colors differ in the region above and below the average value or the target value which functions as a boundary. This makes it easy to ascertain visually whether the actual energy consumption, or the number of steps, exceeds the average value or the target value. It can thus be ascertained whether the routine of exercise for health management is being performed suitably.

It is preferred that the health management report further displays, for each second predetermined period, the number of times in which the activity data has been obtained wherein intensity of activity was above a predetermined value and the intensity of activity was continued longer than a predetermined period.

The activity data, in which the intensity of activity is above a predetermined value and is continued longer than a predetermined period, is obtained when the subject performs exercise voluntarily and intentionally. The number of times in which this activity data has been obtained is displayed. It thus becomes visually apparent to which extent the subject should perform exercise intentionally within the predetermined period, i.e. to make the energy consumption or the number of steps reach the average value or exceed the target value.

In another aspect of the second data processing device, the health management report includes a graph. The period in which the received activity data was obtained (e.g., 1 week) is divided into a plurality of third predetermined periods (e.g., 1 day), and health management report includes a graph displaying, for each third predetermined period, changes over time in the activity data, and a graph displaying a total of time for each state of exercise, this total of time having been obtained by dividing the activity data obtained within the third predetermined periods into a plurality of states of exercise, these states of exercise having been set earlier to correspond to intensity of activity.

Displaying the changes over time in the activity data makes it easy to ascertain visually whether the exercise is being performed for the advised period of time. In addition, displaying the total of time for each of the states of exercise makes it possible to determine whether the total of time of advised exercise is suitable. It is thus possible to know whether the exercise performed for health management is being carried out appropriately, and to make clear which direction future advice should follow.

It is preferred that the health management report further displays energy consumption which has been calculated for each third predetermined period and/or an average value of the energy consumption which has been calculated for each third predetermined period.

Advice concerning exercise for health management is more effectively supported by this addition of a display relating to the energy consumption.

It is preferred that the health management report further marks, in the graph displaying changes over time in the activity data of the third predetermined periods, sections in the activity data in which the intensity of activity was above a predetermined value and was continued longer than a predetermined period.

By marking the sections in which exercise was intentionally performed, it is visually apparent how many times exercise was intentionally performed within the predetermined period, and it is possible to know whether the exercise for health management was effective.

Further, in another aspect of the second data processing device, the health management report includes a plot graph. The period in which the received activity data was obtained is divided into a plurality of fourth predetermined periods. The health management report includes a plot graph having plotted thereon one of ‘either period of exercise or number of steps’ and energy consumption, these having been calculated from the activity data of the fourth predetermined period, and one of ‘either period of exercise or number of steps’ and the energy consumption being on a vertical axis and the other on a horizontal axis.

By displaying the relation between ‘either period of exercise or number of steps’ and the energy consumption, it is possible to realize not just how long exercise was performed and how many steps were taken, but also how much energy was consumed by exercise as a result of the period of exercise and the number of steps. It is thus possible to visually grasp the intensity of exercise at the time when the period of exercise or the number of steps was counted.

It is preferred that the plot graph displays a dividing line dividing the plot graph into a plurality of regions, this dividing line being formed on the basis of a target value for the energy consumption exercise needed to be expended and/or the number of steps needed to be expanded.

This makes it easy to determine whether the target value for the energy consumption and/or the number of steps has been reached.

It is preferred that the plot graph further displays a linear regression line of plotted points.

It is possible to know, from the slope of the linear regression line, the relationship between the energy consumption and the period of exercise or the number of steps. It is thus possible to know whether the intensity of exercise tends to be high or low.

In one aspect of a third data processing device of the present invention, the third data processing device comprises means for receiving activity data transmitted from a measuring device, means for deleting certain activity data from the received activity data, and means for calculating a state of activity.

The deleted activity data is activity data wherein intensity of activity is outside a predetermined threshold range and is continued longer than a predetermined period, or is activity data wherein a number of steps within a predetermined period is outside a predetermined threshold range, this number of steps having been calculated from the activity data.

The activity data which is unsuitable or the activity data which comes from a peculiar period, when exercise was performed markedly below the norm due to sickness or others are deleted from the received activity data. It is thus possible to obtain data from periods when normal life was being led. This maintains the reliability of the data, and makes it possible to provide suitable information for health management.

In another aspect of the third data processing device, the third data processing device further includes means for receiving the activity data transmitted from the measuring device, means for accumulating and storing the received activity data, means for inputting a period wherein state of activity of the subject is evaluated, and means for calculating the state of activity of the subject from the activity data stored in the storing means, these activity data having been obtained within the input evaluating period. Calendar data is inserted at a predetermined time into the activity data received by the receiving means. The calculating means specifies activity data occurring within the input evaluating period out of the activity data stored in the storing means, this specification being performed on the basis of the calendar data inserted into the activity data, and the calculating means calculates the state of activity from the specified activity data.

Inserting the calendar data into the activity data means that the accumulated activity data can be edited freely (integrated or divided) in sequence of time. The activity data occurring within the evaluating period can be specified by means of the calendar data, and it is thus possible to calculate the subject's state of activity within the evaluating period. That is, if any evaluating period is chosen, the health management information concerning this period can be obtained.

Furthermore, a fourth measuring device of the present invention comprises means for measuring movement of the subject, means for storing activity data, which the activity data showing intensity of activity of the subject, this intensity of activity having been determined from the measured movement of the subject, means for producing display data for displaying changes over time in the activity data stored in the activity data storing means, and a display for displaying the changes over time in the activity data based on the display data. In the display, a determined threshold value which has been set for intensity of activity functions as a boundary, and a background color in the case where the intensity of activity is below the threshold value differs from a background color in the case where the intensity of activity exceeds the threshold value.

The changes over time in the activity data are displayed in the display of the measuring device and the subject can ascertain, when desired, changes in his own activity. In this case, if changes over time in the activity data up to and including the displayed time (the present time) are displayed, exercise that has just been performed can be immediately evaluated. Furthermore, the determined threshold value for intensity of activity can function as a boundary and the background colors can differ above and below the boundary. It is thus easy to grasp visually whether exercise is being performed with suitable intensity.

It is preferred that, in the display of the fourth measuring device, the background color in the case where the intensity of activity is below the threshold value is the same color as the background color in the case where the intensity of activity exceeds the threshold value, but the background color is lighter and darker shades of the same color.

Allowing the display to be the same color means that the production costs of the displays can be small.

It is preferred that the fourth measuring device further includes means for inputting a beginning point of the display of changes over time in the activity data, and that in the display, the changes over time in the activity data within a predetermined period are displayed from this input beginning point.

Any beginning point at which the changes over time in the activity data can be selected and past changes in the state of activity are displayed in the display. This makes it possible to gain incentive for exercise in the future.

The present invention can be readily understood by reading the description of the embodiments while referring to the figures described below.

### BRIEF DESCRIPTION OF DRAWINGS

FIG. 1A shows the configuration of the entirety of a health management system.

FIG. 1B shows the configuration of the entirety of the health management system.

FIG. 2 shows an example of data stored in an activity data storing part.

FIG. 3 shows an example of data stored in a medical examination result database.

FIG. 4 shows the procedure whereby a measuring device processes and stores activity data.

FIG. 5 shows the procedure whereby data for producing a health management report is processed.

FIG. 6 shows the procedure of a data acquisition process.

FIG. 7A shows an example of a sum report format.

FIG. 7B shows an example of the sum report format.

FIG. 8 shows an example of a detailed report format.

FIG. 9A shows an example display format of an advice report.

FIG. 9B shows an example display format of an advice report.

FIG. 9C shows an example display format of an advice report.

FIG. 10 shows an example of a display part of the measuring device.

FIG. 11 shows a detailed example of the display part of the measuring device.

### BEST MODE FOR CARRYING OUT THE INVENTION

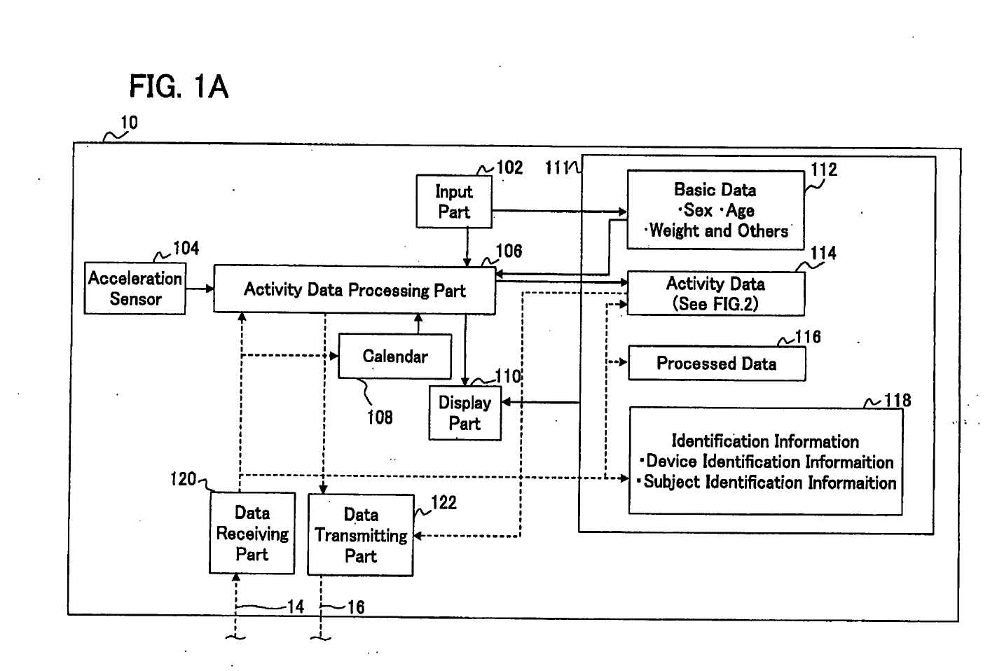

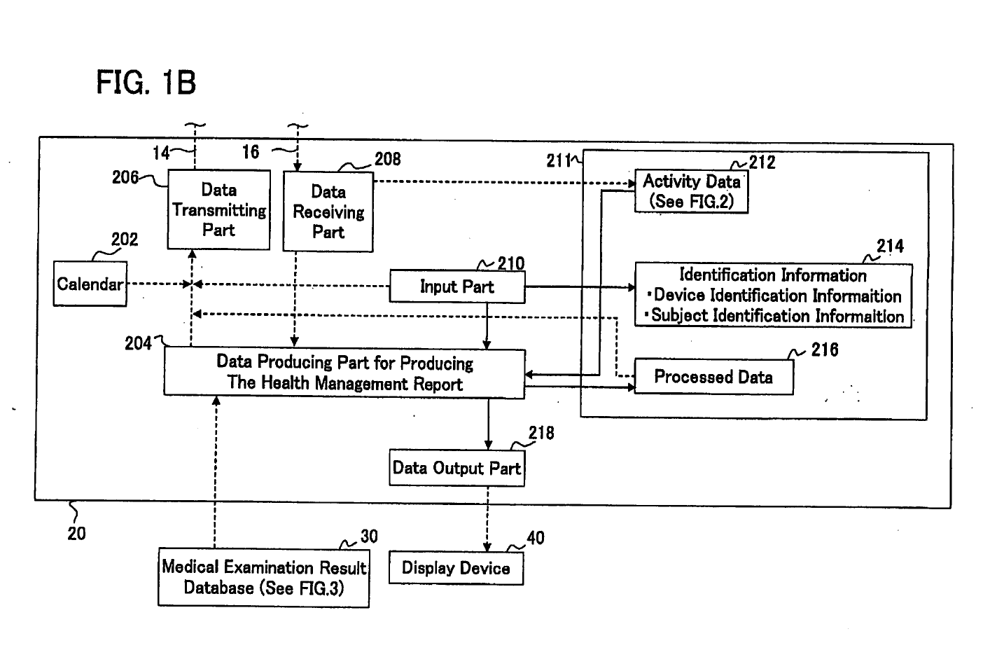

Next, an example of an embodiment of the present invention will be explained. FIGS. 1A and 1B show an entire configuration of a health management system of the embodiment of the present invention. The health management system 1 comprises a measuring device 10, a data processing device 20, a medical examination result database 30, and a display device 40.

First, a summary of the entire health management system 1 will be described.

The measuring device 10 shown in FIG. 1A can be fitted on and carried by a subject (e.g., a person receiving health management advice, hereafter referred to as ‘subject’) to be measured. The measuring device 10 detects acceleration of the device, and produces activity data that indicates the intensity of activity of the subject. The activity data that has been produced is stored within the device.

The data processing device 20 shown in FIG. 1B comprises a conventional, known, normal computer (such as a personal computer). The data processing device 20 performs data processing, for example, to produce a health management report. In the present embodiment, the data processing device 20 is provided in a health management center at a hospital or the like.

The measuring device 10 and the data processing device 20 are connected so as to mutually transmit and receive data, as shown by the arrows 14 and 16. For example, when the subject visits the health management center in order to receive health management advice, the measuring device 10 and the data processing device 20 are connected for mutual communication. The connection between the measuring device 10 and the data processing device 20 can be executed by a variety of known methods (e.g., wire or wireless). (Moreover, in the present embodiment, the connection is executed by wire). When the measuring device 10 and the data processing device 20 are connected, the activity data stored in the measuring device 10 is transmitted to the data processing device 20. The data processing device 20 produces the health management report on the basis of the received activity data.

The medical examination result database 30 shown in FIG. 1 B stores medical examination result data history (a record of data from examination results of the subject: for example, blood, blood glucose values, height, weight.). The medical examination result database 30 is provided in the health management center at the hospital or the like, and can be accessed from the data processing device 20. The data processing device 20 accesses the medical examination result database 30, and acquires required examination result data therefrom. The acquired examination result data is used to produce the health management report.

The display device 40 shown in FIG. 1B is connected with the data processing device 20, and displays the health management report that has been produced by this data processing device 20. The display of a personal computer or the like, can be used as the display device 40. The health management advisor can refer to the health management report displayed in the display device 40, and give health management advice.

The health management report produced by the data processing device 20 can also be transmitted to the measuring device 10, and can be displayed in a display part 110 of the measuring device 10. Further, a printing device such as a printer, instead of the display device 40, may be connected with the data processing device 20. Alternatively, both the printing device and the display device 40 may be connected with the data processing device 20. The health management report may be printed using the printing device.

Next, the configuration of each device of the health management system 1 will be described in detail.

The measuring device 10 shown in FIG. 1A has basically the same configuration as a pedometer or the like. The measuring device 10 comprises an input part 102, an acceleration sensor 104, an activity data processing part 106, a calendar 108, the display part 110, a storage part 111, a data receiving part 120, and a data transmitting part 122. The storage part 111 has a plurality of storage parts 112, 114, 116, and 118.

Basic data, for example, the subject, such as sex, age, weight, can be input via the input part 102 by means of operating a switch or the like. The input basic data is stored in the basic data storage part 112. The basic data stored in the basic data storage part 112 is used by the activity data processing part 106 when this activity data processing part 106 processes the activity data. Furthermore, for example, a command, is input at the input part 102. This inputting is performed so as to display information for health management, which is based on the activity data (to be described later) produced by the activity data processing part 106, in the display part 110.

The acceleration sensor 104 detects acceleration affecting the measuring device 10 (i.e., body movement of the subject fitted with the measuring device 10), and outputs a signal (an analog signal) corresponding to the degree of acceleration. The invention set forth in Japanese Patent Application No. 61-162935 is suitable for use as the acceleration sensor 104.

The activity data processing part 106 converts the signal (i.e., the analog signal) output from the acceleration sensor 104 into acceleration data (a digital signal), and determines the intensity of the activity from this acceleration data. Specifically, the acceleration sensor 104 outputs the amplitude of the wave form of the signal and the ‘intensity of activity’ of the subject is determined every 4 seconds from the amplitude. The ‘intensity of activity’ is determined, on the basis of the strength of activity, to be one of the grades between grade 0 and grade 9. The determined ‘intensity of activity’ is stored sequentially as activity data in the activity data storage part 114. Moreover, this ‘intensity of activity’ is classified, based on its grade, into one of the following states of activity: ‘resting state,’ ‘walking state,’ ‘rapid walking state,’ and ‘running state,’ Thereupon, a ‘state of activity’ representing the state of activity over a 2 minute period is selected from the states of activity that were determined every 4 seconds. The selected ‘state of activity’ is stored sequentially as activity status data in the activity data storage part 114. Japanese Patent Application No. 10-318779, for example, sets forth the detailed procedure of converting the signal from the acceleration sensor 104 into the activity data and activity status data.

In addition to producing the activity data and activity status data, the activity data processing part 106 uses the basic data and the activity data to compute the ‘number of steps’ and the ‘energy consumption by exercise’ for each period for producing activity data. The activity data processing part 106 computes the ‘number of steps’ by counting the waveform of the signal from the acceleration sensor 104 during one of ‘states of exercise’ (either the ‘walking state,’ the ‘rapid walking state,’ and the ‘running state’). The ‘energy consumption’ is calculated by multiplying a consumption index, the period of exercise or the number of steps, and a metabolic index. The consumption index has been determined earlier for each ‘intensity of activity’ (e.g., 0.2 may be for ‘grade 3’, 0.3 may be for ‘grade 7’, and 0.9 may be for ‘grade 9’). The metabolic index is determined from the basic data of the subject, including sex, age, weigh. For example, when the ‘intensity of activity’ of ‘grade 3’ activity data has been produced, the consumption index of 0.2, the period of exercise (e.g., 1 minute), and the metabolic index (e.g., 10) are multiplied, and the energy consumption is calculated to be 2 calories. The ‘number of steps’ and the ‘energy consumption’ are stored, like the activity data and the activity status data, in the activity data storage part 114. Moreover, the activity data processing part 106 calculates ‘total of time of each intensity of activity,’ ‘total of time of each state of activity,’ ‘total of number of steps,’ ‘total of consumption of energy by exercise,’ and ‘sum consumption of energy.’ The ‘total of time of each intensity of activity’ is calculated by multiplying the number of items of activity data of each ‘intensity of activity’ (i.e., the aforementioned 10 grades) by a time that encompasses a determined period for producing the activity data. The ‘total of time of each state of activity’ is calculated by adding the ‘total of time of each intensity of activity’ for each of the ‘states of activity’ (i.e., the four states described above) which the ‘intensity of activity’ is classified into. The ‘total of number of steps’ is calculated by accumulating the ‘number of steps’ that was calculated in the manner described above. The ‘total of consumption of energy by exercise’ is calculated by accumulating the ‘consumption of energy by exercise’ that was calculated in the manner described above. The ‘sum consumption of energy’ is calculated by adding the consumption of energy using the ‘resting state,’ and basal metabolic rate, to the ‘total of consumption of energy by exercise.’ Moreover, the energy consumption during the ‘resting state,’ and the basal metabolic rate are determined, like the aforementioned metabolic index, on the basis of the basic data such as sex, age, weight The ‘total of time of each intensity of activity,’ ‘total of each state of activity,’ ‘total of steps,’ ‘total of consumption of energy by exercise,’ and ‘sum consumption of energy’ are calculated for each period of 1 day, and are stored in the activity data storage part 114.

Further, the ‘number of steps,’ ‘energy consumption,’ ‘total of time of each intensity of activity,’ ‘total of time of each state of activity,’ ‘total of number of steps,’ ‘total of consumption of energy,’ and ‘sum consumption of energy’ are displayed in the display part 10 by means of performing a determined operation on the input part 102.

The calendar 108 is provided with a timer that times the date and hour. The calendar 108 produces calendar data on the basis of the date and hour that are timed by the timer. The calendar data is inserted at a determined period into the activity data produced by the activity data processing part 106. The inserted calendar data is stored, together with the activity data, in the activity data storage part 14. If, for example, a period for producing the activity data is 1 minute, and the period for inserting calendar data is 10 minutes, 1 item of calendar data is stored while 10 items of activity data are stored. In the present embodiment, the calendar data inserted into the activity data can function as a key which tabulates and processes the activity data for a determined period (such as 1 day), or for a longer specified period (such as 1 week or 1 month). If, for example, a blank period, in which activity data was not produced, were to appear due to battery failure or the like of the measuring device 10, the calendar data can function as a key which unites the activity data obtained before the blank period and the activity data obtained after this blank period. In this manner, activity data that was obtained on differing dates and hours can be evaluated collectively.

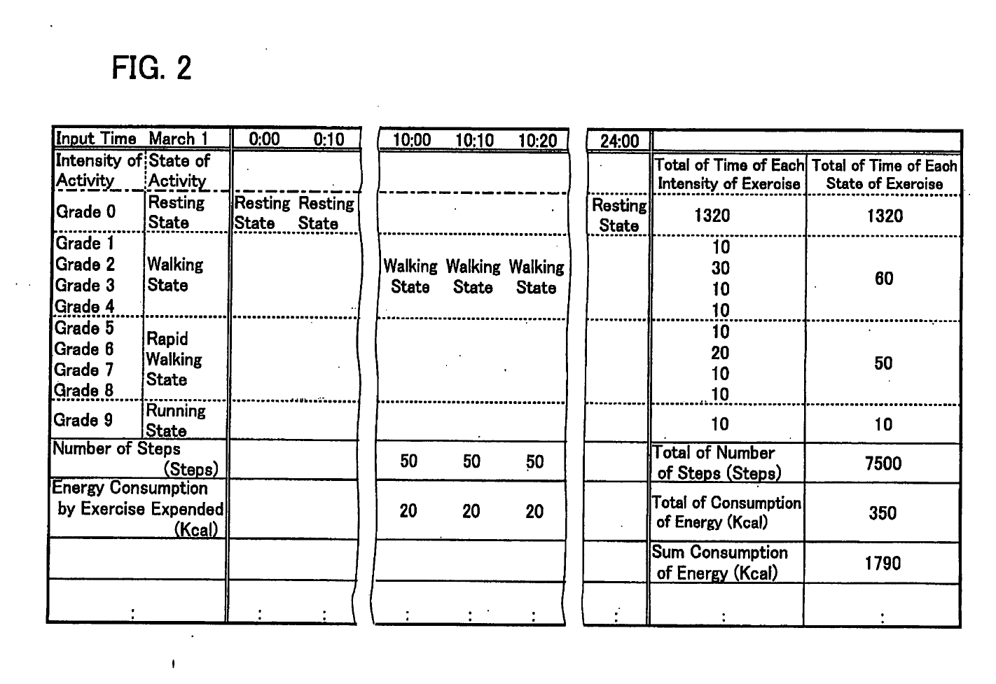

The activity data storage part 114 stores the activity data and the activity status data processed by the activity data processing part 106, and also stores the aforementioned ‘number of steps,’ ‘energy consumption,’ ‘total of time of each intensity of activity,’ ‘total of time of each state of activity,’ ‘total of number of steps,’ ‘total of consumption of energy,’ and ‘sum consumption of energy.’ The activity data storage part 114 is provided with a plurality of regions that store the data produced in 1 day, and a maximum of 6 weeks of data can be stored. FIG. 2. schematically shows an example of data stored in the activity data storage part 114 over a period of 1 day. FIG. 2. shows the activity status data. Each of activity data is graded into one of the grades of ‘intensity of activity,’ the grades from grade 0 to grade 9, and each of the ‘intensity of activity’ is classified into one of the four ‘states of activity.’ The ‘states of activity’ shown here are representative ‘states of activity’ for the period for inserting calendar data. Further, each item of data, for the period for inserting calendar data, has been accumulated in the columns ‘number of steps,’ and ‘energy consumption.’ Each of the ‘number of steps,’ and ‘energy consumption’ is stored as the data that changes overtime. The ‘total of time of each intensity of activity,’ ‘total of time of each state of activity,’ ‘total of number of steps,’ ‘total of consumption of energy by exercise,’ and ‘sum consumption of energy’ form one item of data that is obtained by tabulating the total data of one day.

The processed data storage part 116 stores data processed by the data processing device 20 for the health management report. This data for the health management report will be described in detail later.

Returning to FIG. 1A, the identification information storage part 118 stores identification information that identifies the measuring device 10 (referred to hereafter as ‘device identification information’), and identification information that identifies the subject (referred to hereafter as ‘subject identification information’). The device identification information is set by the maker at the time of manufacturing the measuring device 10, and cannot be altered thereafter. For example, the specifications of the measuring device can be determined using the device identification information. This enables maintenance, such as repair in the event of malfunction, to be performed rapidly.

The subject identification information is set by means of the data processing device 20, and can be altered only by means of the data processing device 20. This prevents the health management advisee from accidentally altering the subject identification information. Furthermore, the health management advisor can set, as desired, the subject identification information from the data processing device 20. It is, for example, possible to set the subject identification information for each subject belonging to one group that has a part in common with the other's (e.g., the first digit is in common). This allows the retrieval of subjects belonging to a group. It is thus easy to perform processing such as calculating the average amount of exercise of a group. Comparing the average amounts of exercise between groups may give a group member greater incentive to engage in exercise. The procedure of setting the subject identification information using the data processing device 20 will be described later.

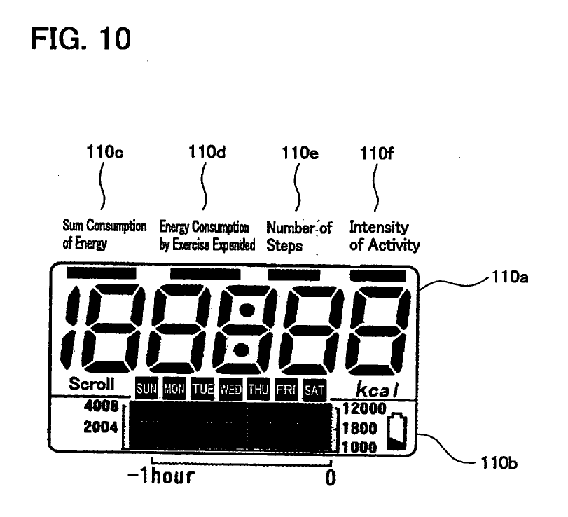

The display part 110 is formed from a liquid-crystal display. The display part 110 displays each type of data stored in the activity data storage part 114 (the ‘intensity of activity, ’ ‘number of steps,’ ‘energy consumption,’ ‘total of time of each intensity of activity,’ ‘total of time of each state of activity,’ ‘total of number of steps,’ ‘total of consumption of energy by exercise,’ and ‘sum consumption of energy’). FIG. 10 shows a screen displayed in the display part 110. ‘Sum consumption of energy,’ ‘energy consumption by exercise,’ ‘number of steps,’ and ‘intensity of activity,’ are shown as numbers displayed digitally in an upper part 110a of the display part 110. When the ‘sum consumption of energy’ is displayed in the upper part 110a, an area directly below a part 110c labeled ‘sum consumption of energy’ is illuminated. Similarly, when ‘energy consumption by exercise,’ ‘number of steps,’ or ‘intensity of activity’ is displayed, the area is illuminated directly below a corresponding labeled part 110d, 110e, or 110f respectively. The upper part 110a further displays, for example, the date and hour of the calendar data produced by the calendar 108, and graphs (to be described later) of the health management report stored in the processed data storage part 116. Switching between the items of information displayed by the upper part 110a is performed by operating a switch or the like of the input part 102.

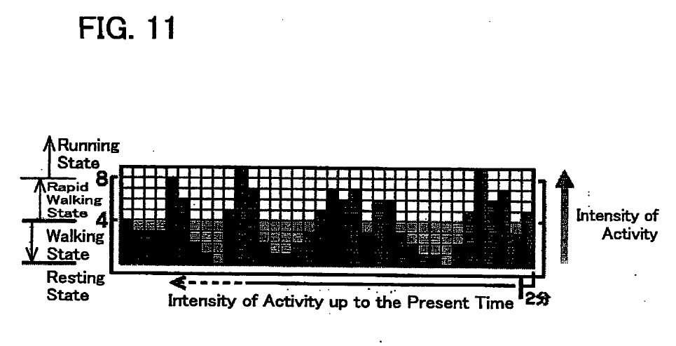

Each item of data in the activity data storage part 114, such as ‘intensity of activity,’ ‘state of activity,’ ‘number of steps,’ ‘energy consumption’, is stored in sequence of time. Consequently, these items of data are displayed in sequence of time in a lower part 110b of the display part 110. FIG. 11 shows an example of a display in sequence of time shown in the lower part 110b. In FIG. 11, the vertical axis means the ‘intensity of activity’ (i.e., the aforementioned 10 grades), and the horizontal axis means time (e.g., 1 unit=2 minutes). Furthermore, the left side vertical axis also shows the divisions of the ‘states of activity.’ In this graph, changes in the ‘state of activity’ over 2 minute intervals are shown in sequence of time beginning from the left. The background color of the graph in the lower part 110b of the display part 110 can be varied to be two-toned (lighter and darker shades of the same color). The color changes at a boundary of a threshold value. In FIG. 11, ‘grade 4’ of the ‘intensity of activity’ (e.g., the ‘walking state’ of the ‘states of activity’) has been selected as the threshold value, and the background color is varied to be lighter and darker shades of the same color. It can thus easily be seen whether the ‘intensity of activity’ has exceeded the predetermined threshold or not Further, in FIG. 11, when the display is performed in sequence of time, the time axis has a scale of 62 minutes (approximately 1 hour). The scale of the time axis can be varied, by operating the input part 102, to be between 15 minutes to 24 hours. By this means, changes in the ‘intensity of activity’ within, for example, 15 minutes or 1 day can easily be seen. Moreover, the time at which the display of the data begins (shown in the lower part 110b of the display part 110 in FIG. 10) can be varied by operating the input part 102. Specifically, it is possible to scroll cyclically through and display the changes of the ‘intensity of activity’ over time in the lower part 110b by operating an arrow key, or the like, of the input part 102. Furthermore, the word ‘scroll,’ this appearing in the upper part 110a, shows that the changes of the ‘intensity of activity’ over time are being scrolled through and displayed in the lower part 110b.

Imagining a case where, for example, the ‘intensity of activity’ from the present time to 4 days previously can be displayed, and the ‘intensity of activity’ over the past 24 hours to the present time is currently displayed in the display part 110. Operating the input part 102 towards the past shifts the entire display towards the right, and the ‘intensity of activity’ further in the past is displayed. Next, operating the input part 102 towards the future shifts the entire display towards the left, and the ‘intensity of activity’ displayed returns towards the present time. By continuing this shifting, the graph passes through an entire cycle, and the beginning of ‘intensity of activity’ data at the right end of the graph is displayed (i.e., the ‘intensity of activity’ of 4 days previously).

Consequently, if the scale of the time axis is set to be 15 minutes, the ‘intensity of activity’ from the present time to 15 minutes previously is displayed, and it is easy to determine whether exercise that was just performed was effective. Further, if the scale of the time axis is set to be 1 day, the ‘intensity of activity’ from the present time to 1 day previously is displayed, and it is easy to determine whether adequate exercise has been performed over the preceding day.

Returning to FIG. 1A, the data transmitting part 122 transmits data from the measuring device 10 to the data processing device 20. Data transmitted by the data transmitting part 122 includes, for example, the activity data stored in the activity data storage part 114, or the device identification information or subject identification information stored in the identification information storage part 118. The data receiving part 120 receives data transmitted from the data processing device 20. Data received by the data receiving part 120 includes, for example, the calendar data for correcting the timer of the calendar 108, or data for setting the subject identification information.

The data processing device 20 shown in FIG. 1B comprises a calendar 202, a data producing part 204 for producing the health management report, a data transmitting part 206, a data receiving part 208, an input part 210, a storage part 211, and a data output part 218. Further, the storage part 211 has a plurality of storage parts 212, 214, and 216.

The calendar 202, like the calendar 108 of the measuring device 10, has a timer that times the date and hour. The calendar 202 produces calendar data on the basis of the date and hour that are timed by the timer. When the data processing device 20 and the measuring device 10 are connected to mutually transmit and receive the data, the calendar data produced by the calendar 202 is transmitted from the data processing device 20 to the measuring device 10. When the measuring device 10 receives the calendar data, it corrects the timer of the calendar 108 to align with the date of the received calendar data. Non-alignment between the calendar data of the data processing device and the timer of the measuring device is thus corrected.

Correcting the timer of the calendar 108 of the measuring device 10 may cause a blank period to appear in the activity data stored in the activity data storage part 114. In this case, dummy data (e.g., data that has the same values as the period before and after the blank period) is automatically inserted into the blank period. Alternatively, correcting the timer may cause an overlap of the activity data stored in the activity data storage part 114. In this case, the activity data that has been produced more recently overwrites, and is stored in the activity data storage part 114, and other activity data is deleted.

The data producing part 204 produces the health management report on the basis of the activity data transmitted from the measuring device 10 and on the basis of the examination result data acquired from the medical examination result database 30. As will be described, when the activity data is transmitted from the measuring device 10 to the data processing device 20, the device identification information and the subject identification information are transmitted simultaneously. The data producing part 204 specifies the subject on the basis of the subject identification information, and acquires the examination result data of that subject from the medical examination result database 30.

For example, setting the subject identification information to be stored in the measuring device 10, or indicating the display format of the health management report is performed from the input part 210. The procedure of setting the subject identification information is as follows. First the measuring device 10, where the subject identification information is set, is connected with the data processing device 20. Next, the subject identification information is input from the input part 210 of the data processing device 20, and an execute switch is operated. By this means, the subject identification information input from the input part 210 is transmitted from the data transmitting part 206 to the measuring device 10, overwrites and is stored in the identification information storage part 118 of the measuring device 10. Further, the data processing device 20 reads the device identification information from the measuring device 10, and replaces the subject identification information (this being stored in the identification information storage part 214) corresponding to this device identification information with the input subject identification information. By means of the above process, the measuring device 10 and the data processing device 20 store same identification information.

The activity data storage part 212 correlates the activity data transmitted from the measuring device 10 with the subject identification information, and stores this activity data. A plurality of measuring devices 10 are connected with the data processing device 20, and each measuring device transmits different activity data. Consequently, the activity data storage part 212 stores the activity data that has been received for each of the subjects (i.e., for each item of subject identification information). Further, as described above, the calendar data is inserted into the activity data transmitted from the measuring device 10, and consequently the calendar data is also inserted into the activity data stored in the activity data storage part 212. It is consequently possible, using this calendar data, to fetch only the activity data concerning the period about which one wants to produce a health management report. That is, the activity data can be edited (integrated or divided) in sequence of time.

The identification information storage part 214 stores the subject identification information as well as the device identification information of the plurality of measuring devices 10 controlled by the data processing device 20. In the present embodiment, a plurality of items of subject identification information are correlated with one item of device identification information. One measuring device 10 can thus be used by a plurality of people.

The processed data storage part 216 stores data for the health management report that has been produced by the data producing part 204. The stored data is output from the data output part 218 to the display device 40 in response to orders input from the input part 210. The health management report is displayed in the display device 40 on the basis of the data that has been output. The stored data is further transmitted from the data transmitting part 206 to the measuring device 10.

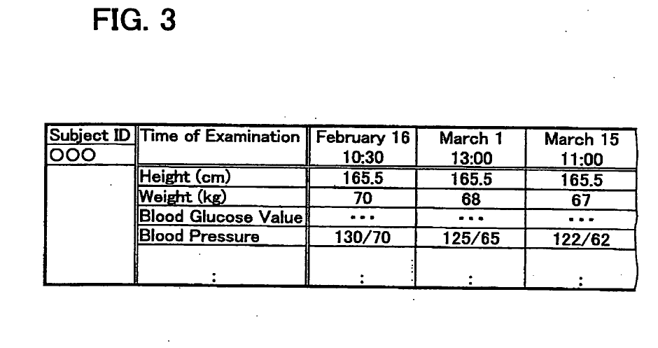

The medical examination result database 30 shown in FIG. 1B stores the medical examination result data history of the subject. These examinations have been performed at the health management center at the hospital's or the like. The stored data is, for example, height, weight, blood glucose values, blood pressure, temperature which was measured before exercising (such as a first medical examination prior to advice to exercise) and after exercising (such as a medical examination subsequent to advice to exercise). Consequently, health improvements brought about through exercise can be understood easily. Furthermore, the examination result data history is correlated with the subject identification information and is stored. FIG. 3 shows an example of the data configuration of the medical examination result database 30. A ‘subject ID’ correlated with the examination result data is identical with the subject identification information stored in the identification information storage parts 118 and 214. The data processing device 20 retrieves the medical examination result database 30 using the subject identification information as a key and acquires the required examination result data. Further, the data processing device 20 retrieves the medical examination result database 30 using a part of the subject identification information which is common in the group (e.g., the first digit) as a key and acquires the data of a plurality of subjects belonging to the group. It is thus possible to perform various processing using the group as a unit, such as calculating the average values of data of each group and comparing average values between groups.

Next, the processing procedure for producing a health management report will be described. Before this processing, it is necessary to measure the activity of the subject using the measuring device 10. Further, before measuring the activity of the subject, the measuring device 10 is set with the subject identification information and the basic data of the subject. The measuring device 10 begins measuring after being set with this data, and stores the activity data.

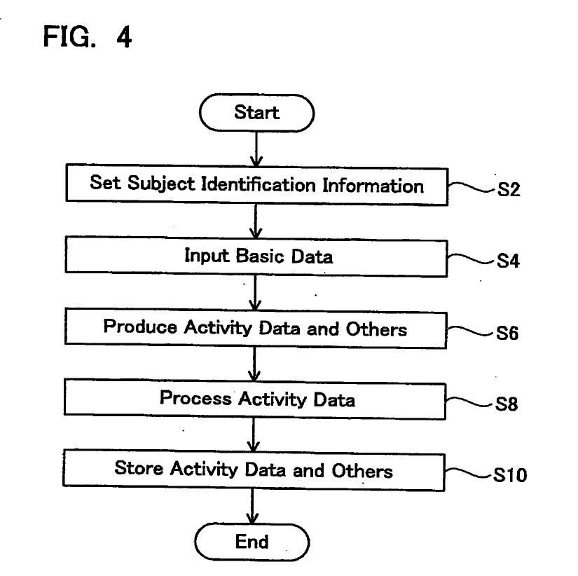

That is, as shown in FIG. 4, the measuring device 10 carried by the subject is connected with the data processing device 20, and the subject identification information is set by means of the data processing device 20 (step S2). When the subject identification information has been set, this subject identification information is stored in the identification information storage part 118 of the measuring device 10 and in the identification information storage part 214 of the data processing device 20.

In step S4, the basic data is input via the input part 102 of the measuring device 10. Input of the basic data is performed via the measuring device 10 because data such as weight undergo daily fluctuations. Consequently, the process of step S4 is performed personally by the subject, for example, on each day of measuring before the measuring device 10 is fitted, after being weighed.

After the subject identification information has been set, and after the basic data has been input, the measuring device 10 is fitted to the subject, and the following is performed: the activity data and others are produced (step S6), the activity data is processed (step S8), and the activity data and others are stored (step S10).

In step S6, the ‘intensity of activity’ of the subject is classified into 10 grades on the basis of the signal output from the acceleration sensor 104. The activity data is thus produced. Furthermore, the activity status data is also produced, in which the ‘intensity of activity’ is classified into four states: ‘resting state,’ ‘walking state,’ ‘rapid walking state,’ and ‘running state’.

In step S8, in which the activity data is processed, the activity data produced in step S6 is processed, and the following are calculated: ‘energy consumption by exercise,’ ‘total of time of each intensity of activity,’ ‘total of consumption of energy by exercise,’ ‘sum consumption of energy’.

In step S10, in which the activity data and others are stored, the activity data and the activity status data produced in step S6, and the data processed in step S8, are stored in the activity data storage part 114.

The processes from step S6 to step S10 are performed constantly while the subject is carrying the measuring device 10 (more precisely, while the measuring device 10 is not connected with the data processing device 20), and the activity data and other data of the subject are stored in the activity data storage part 114.

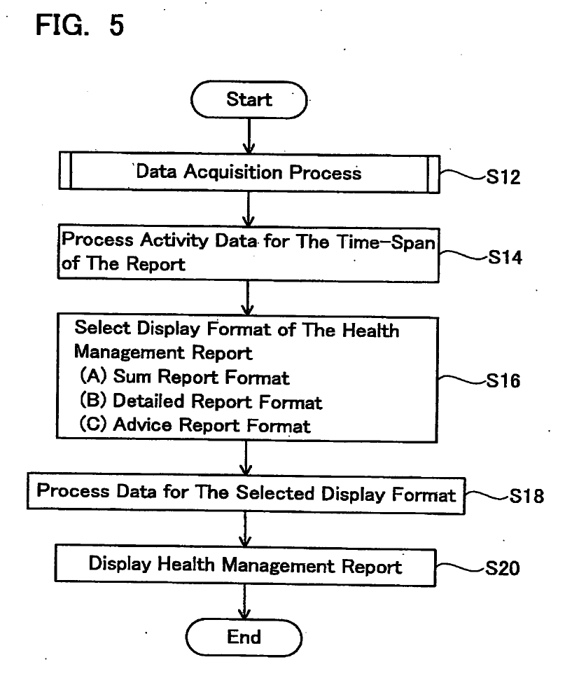

A description follows, with reference to FIG. 5, of the process whereby the data processing device 20 produces the health management report.

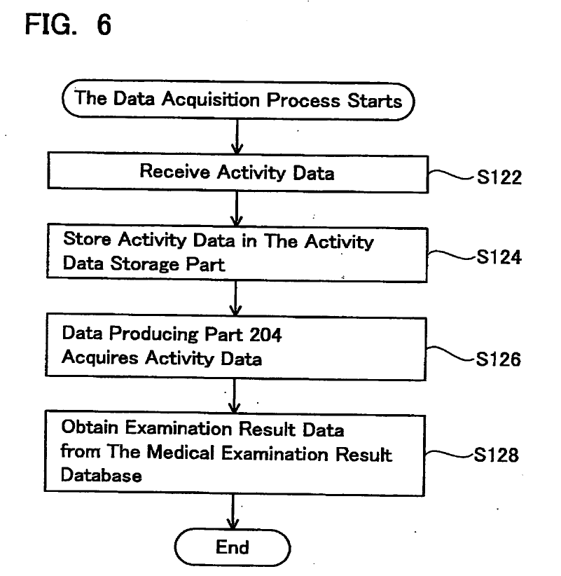

In the process for producing the health management report, the data processing device 20 first acquires data in step S12. Specifically, the data processing device 20 acquires the stored activity data from the measuring device 10. Furthermore, the data processing device 20 acquires the examination result data that is stored in the medical examination result database 30. The process of step S12 is described in more detail with reference to FIG. 6.

As shown in FIG. 6, the data processing device 20 first receives the activity data, the device identification information and the subject identification information from the measuring device 10 by means of the data receiving part 208 (step S122). In the present embodiment, a data cable is utilized for data communication between the measuring device 10 and the data processing device 20. However, any other existing means may also be utilized, such as communication using infrared rays, communication networks using normal telephone lines. By this means, the activity data storage part 114 of the measuring device 10 is cleared in preparation for subsequent storage of activity data.

Moreover, when the activity data is received in step S122, the calendar data is transmitted from the data processing device 20 to the measuring device 10. The timer of the measuring device 10 is thus corrected and brought into alignment with the timer of the data processing device 20.

The activity data received in step S122 is stored, for each item of subject identification information, in the activity data storage part 212 (step S124). Further, this activity data is output to the data producing part 204 (step S126).

Next, the data producing part 204 acquires the examination result data history of the subject (see FIG. 3), this having been specified on the basis of the received subject identification information, from the medical examination result database 30 (step S128).

The data acquisition process is thus completed, the process returns to step S14 of FIG. 5, and the data producing part 204 processes the activity data for the time-span of the report. Here, the time-span of the report is 6 weeks and, chiefly, processing of the items below is performed. The time-span of the report can be set as desired from the input part 210 of the data processing device 20.

Processing of the Activity Data

(1) Editing (integrating or dividing) the activity data into data of 6 week periods in sequence of time

If, for example, the data stored in the measuring device 10 is for a 3 week period, the received activity data is only for 3 weeks and is insufficient. Consequently, at step S14, the activity data of the previous 3 weeks stored in the activity data storage part 212 is read again. Since the calendar data is inserted into the activity data, this calendar data can be used as a key to acquire the appropriate activity data. The acquired activity data is integrated in sequence of time on the basis of the calendar data

(2) Deleting the data for days in which the period is longer where ‘intensity of activity’ does not fit within a predetermined threshold range

For example, the threshold range is such that the ‘number of steps’ is above 50 steps per day, and the period of the ‘state of activity’ is between 15 minutes and 3 hours per day. If the data is from days in which it does not belong within this threshold range, it is deleted automatically. This excludes the data from days in which activity was not routine (e.g., sick days spent in bed, days in which intense and atypical exercise (such as mountain climbing) took place over a long period, days in which the subject forgot to fit the measuring device). This allows reliable values to be obtained in the processes that follow.

At step S16 of FIG. 5, the display format of the health management report is indicated by means of the input part 210. In the present embodiment, (A), (B), or (C) can be selected. (A) is a ‘sum report format’ in which the state of activity for the time-span of the report (6 weeks) is tabulated to allow determined periods (1 day) to be compared. (B) is a ‘detailed report format’ in which the state of activity for determined periods is reported in detail. (C) is an ‘advice report format’ in which the report is used for health management advice.

Furthermore, the items reported in all of the display formats are chiefly any of the following items, or anything produced on the basis of the following items: (1) weight (from processing the examination result data), (2) energy consumption by exercise (from processing the activity data), (3) sum consumption of energy (from processing the activity data), (4) period of each state of activity (from processing the activity data), (5) number of steps (from processing the activity data).

The procedure will now be explained for the case where (A) (‘the sum report format’) has been selected at step S16 of FIG. 5.

At step S18, data for the ‘sum report format’ is processed. Chiefly, the items below are processed.

Processing of the Activity Data

(1) Calculating a total value and an average value of the data of a set period (1 week, 6 weeks) and obtaining the maximum and minimum values. The activity data deleted in step S14 is not utilized.

(2) Setting a target value for each of the items

For example, the target value for ‘energy consumption’ is set to be above 300 kilocalories per day, or above 2000 kilocalories per week (values are based on data obtained by Paffenburger et al showing results of continued exercise). Alternatively, weight (kg)×5 (kilocalories) is calculated to obtain a value of the calories expended per day, and the target value is set to be above this value. Further, the target value for the ‘number of steps’ is set to be above 10 000 steps per day.

Processing of the Examination Result Data

(1) Calculating normal weight from the height data, and deviation from normal weight as well as upper and lower thresholds of normal weight range from the weight data

Normal weight is calculated using the method of the Japan Society for the Study of Obesity ‘(height in meter)²×22.’ Furthermore, the upper and lower thresholds of normal weight range are determined from a numerical value obtained by using one of the indices for displaying obesity: i.e. BMI ‘(weight in kg)÷(height in meter)²’.

Processing for Displaying the ‘Sum Report Format’

(1) Processing for the graphic display of, for example, graphs, charts

At step S20 of FIG. 5, the health management report is displayed in the display device 40 (or in the display part 110 of the measuring device 10) using the ‘sum report format’ of (A) above.

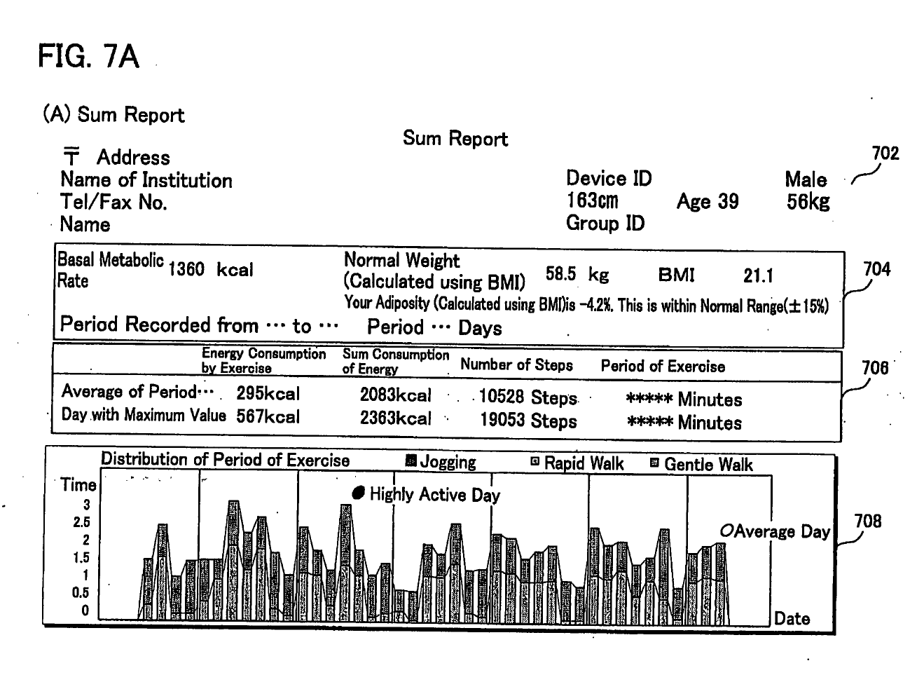

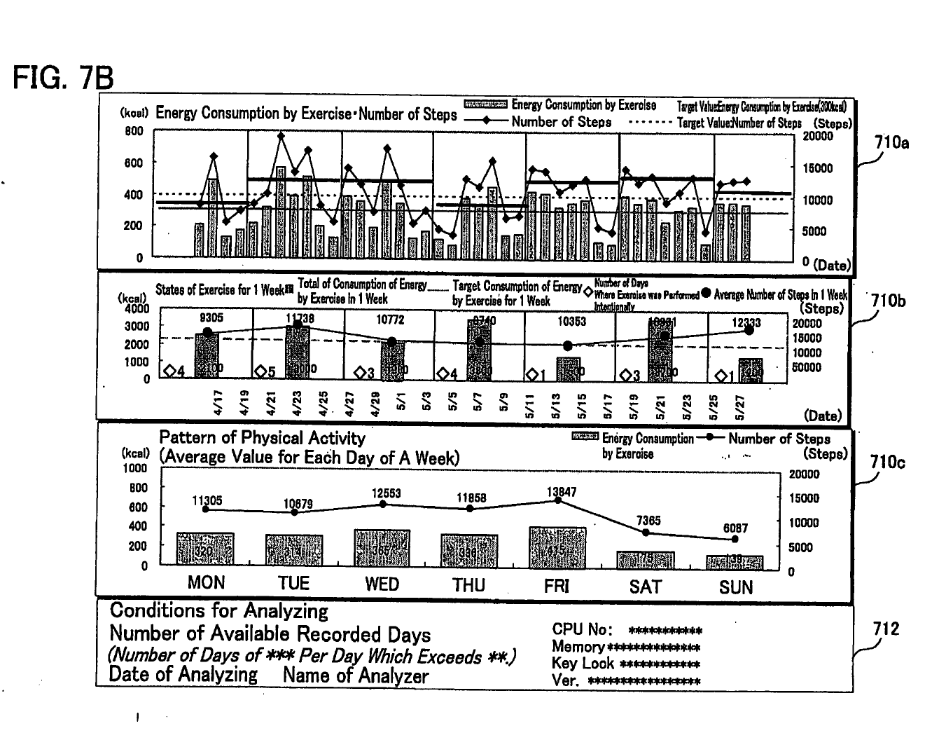

FIG. 7A and FIG. 7B show sample displays of the health management report using the ‘sum report format’ (A).

702 of FIG. 7A displays the name and basic data of the subject (sex, age, weight, height) as well as the device identification information (device ID). It is thus clear which measuring device of which subject has provided the data on which the report is based.

In the sample display, the group ID of the subject is shown. The group ID is set to be a part of the subject identification information (e.g., the first digit). The group ID is used if health management is given to a plurality of subjects. These subjects have been grouped together on the basis of a determined category (e.g., weight). It is possible, using the group ID, to extract only the data of the subjects belonging to the group.

704 shows items concerning (1) weight. Basal metabolic rate, normal weight and BMI are shown which have been calculated from weight and height at the time when measurement began of the states of activity.

706 shows items relating to (from left): (2) ‘energy consumption by exercise,’ (3) ‘sum consumption of energy,’ (5) ‘number of steps,’ and (4) ‘period of each state of activity’ (labeled as ‘period of exercise’). An average value and a maximum value for a period of 6 weeks are shown. Here, the ‘period of exercise’ is a total of ‘states of exercise’ (this being, out of the four ‘states of activity,’ the ‘walking state,’ the ‘rapid walking state,’ and the ‘running state.’). Time spent in the ‘resting state’ is not included.

708 displays (4) ‘period of each state of activity’ (labeled as ‘period of exercise’) in graph form. Out of the totals of ‘period of exercise’ over the 6 weeks, days that have the maximum value are marked as ‘highly active days’ (a black circle), and days that have an average value are marked as ‘average days’ (a white circle). It is also possible to display detailed records of conditions of activity shown in the ‘advice report format’ of (C) (to be described later) by performing a display operation, such as clicking on the marked portions.

710a, 710b, and 710c of FIG. 7B display, in graph form, the relationship between (2) ‘energy consumption by exercise’ and (5) ‘number of steps.’ 710a displays, for each period of 1 day, the ‘energy consumption by exercise’ using a bar graph, and the ‘number of steps’ using a polygonal line. Further, the average value of the ‘energy consumption by exercise’ for each period of 1 week is calculated and this average value forms a boundary at which the background color changes (in the present embodiment, the bold solid line extending in the horizontal direction is the boundary, and the background color differs above and below this line). Instead, the target value of the ‘energy consumption by exercise’ may form the boundary above and below which the background color varies (in the present embodiment, the target value is shown by the dotted line extending in the horizontal direction). Varying the background color in this manner makes it easy to visually grasp the average value or the target value.

In 710b, the contents of the graphs in 710a are totaled for each 1 week period and are displayed. The numbers are shown together with rhomboid shapes at the left of the bar graphs. These numbers show the number of days in which exercise having an intensity above a predetermined value was continued longer than a predetermined period (e.g., the number of days in which exercise that had an intensity greater than ‘rapid walking’ was performed longer than 20 minutes). This makes clear the number of times that exercise was intentionally performed in the 1 week period.

In 710c, the contents of the graphs in 710a are totaled for each day of the week and are displayed.

By displaying the total exercise for each 1 week period or the total exercise of a day of the week, it is easy to visually grasp, for example, weekly or daily characteristics of the energy consumption by exercise.

In the graphs of 710b and 710c, also, the average value or target value of the ‘energy consumption by exercise’ may form a boundary above and below which the background color varies. If the boundary at which the background color changes is formed by the average value, with looking at number of times of intentional exercise of 710b, it is possible to determine the extent to which the intentional exercise should be performed within the 1 week period to reach the target value.

712 shows ‘number of available recorded days.’ This is the number of days out of the 6 weeks in which available data was obtained. Days in which the obtained data was not within the predetermined threshold range are excluded.

Next, there will be a description of the processing procedure if the ‘detailed report format’ (B) has been selected at step S16 of FIG. 5.

At step S18, data for the ‘detailed report format’ is processed. Chiefly, the items below are processed.

Processing of the Activity Data

(1) Calculating a total value and an average value of the data of a preset period (e.g., 1 week), and obtaining the maximum and minimum values. The activity data deleted in step S14 is not utilized.

(2) Setting a target value for each of the items

Processing for Displaying the ‘Advice Report Format’

(1) Processing for the graphic display of, for example, graphs, charts

At step S20 of FIG. 5, the health management report is displayed in the display device 40 (or in the display part 110 of the measuring device 10) using the ‘detailed report format’ (B) above.

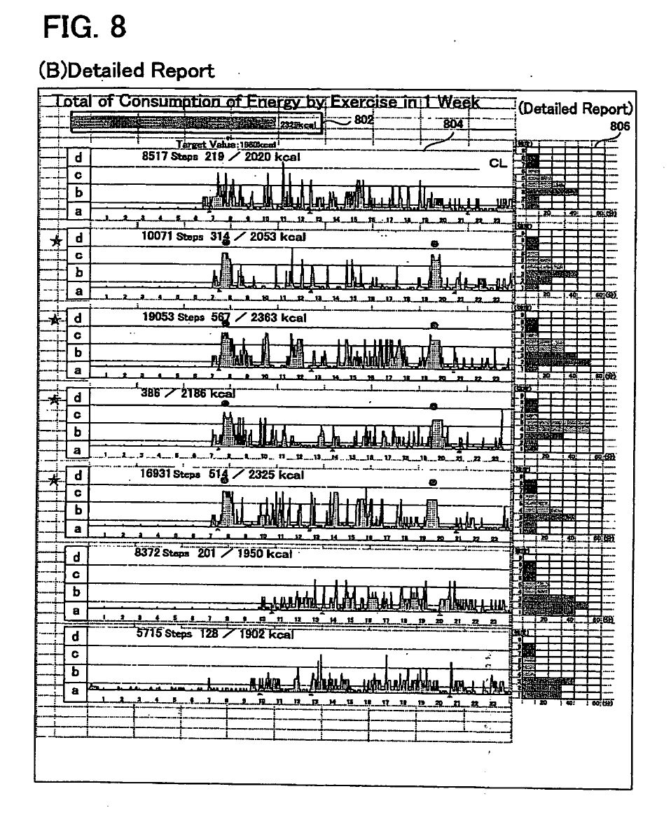

FIG. 8 shows a sample display of the health management report using the ‘detailed report format’ (B). In the ‘detailed report format’ shown in FIG. 8, detailed records of conditions of activity for 1 day periods are displayed in 1 week units.

802 shows items relating to (2) ‘energy consumption by exercise.’ The total value of 1 week is shown, and below this the target value is shown.

804 shows (4) ‘period of each state of activity’ in sequence of time. The ‘states of activity’ are divided into four on the left edge of the graph. a shows the ‘resting state,’ b shows the ‘walking state,’ c shows the ‘rapid walking state,’ and d shows the ‘running state.’ The background may vary in color with a predetermined value (e.g., the target value) functioning as the boundary between the colors. Further, (5) the ‘number of steps,’ (2) the ‘energy consumption by exercise,’ and (3) the ‘sum consumption of energy’ are also shown in an upper part of the background. Moreover, days in which the ‘energy consumption by exercise ’ reaches the target value are marked by a star at the left edge of the graph. Black circles are marked in the backgrounds of Tuesday, Wednesday, Thursday, and Friday. In the portions with a black circle, exercise which has an intensity above a predetermined value was continued longer than a predetermined period (i.e., exercise was intentionally performed). By showing the ‘states of activity’ in sequence of time in this manner, it is possible to determine whether exercise of the advised intensity was performed during the advised period. Further, the star and the black circle clarify the relationship between the ‘energy consumption by exercise’ and the number of times that exercise was intentionally performed in one day. It can be understood, for example, how many times exercise must be intentionally performed in order to reach the target value of the ‘energy consumption by exercise.’ Further, the display ‘CL’ in the upper right of the background of Monday shows that data was deleted for this day because this data did not fit within the determined threshold range (consequently, the data for Monday is not actually displayed). Moreover, the entirety of one day might not be displayed if this report format is displayed in the display part 110 of the measuring device 10. In this case, the time desired can be selected by scrolling the display horizontally.

806 displays the total of (4) ‘period of each state of activity.’ Displaying 804 and 806 in parallel makes it easy to grasp which state of activity was performed at which time, and how long the total of time of these states of activity was.

Below is a description of the processing procedure if the ‘advice report format’ (C) has been selected at step S16 of FIG. 5.

At step S18, data for the ‘advice report format’ is processed. Chiefly, the items below are processed.

Processing of the Activity Data

(1) Calculating a total value and an average value of the data of the preset period (6 weeks), and obtaining the maximum and minimum values. The activity data deleted in step S14 is not utilized.

(2) Setting a target value for each of the items

(3) Calculating the rate at which the target value of the ‘sum consumption of energy’ has been achieved

This is calculated as follows, and is then displayed as a percentage:
target value (kilocalories)÷actual consumption (kilocalories).
Processing of the Examination Result Data
(1) Calculating weight difference between the time when measuring was begun and measuring was completed (i.e., 6 weeks later).
(2) Calculating normal weight from the height data, and deviation from normal weight as well as upper and lower thresholds of normal weight range from the weight data.
Processing for Displaying the ‘Advice Report Format’
(1) Processing for the graphic display of, for example, graphs, charts

At step S20 of FIG. 5, the health management report is displayed in the display device 40 (or in the display part 110 of the measuring device 10) using the ‘advice report format’ of(C) above.

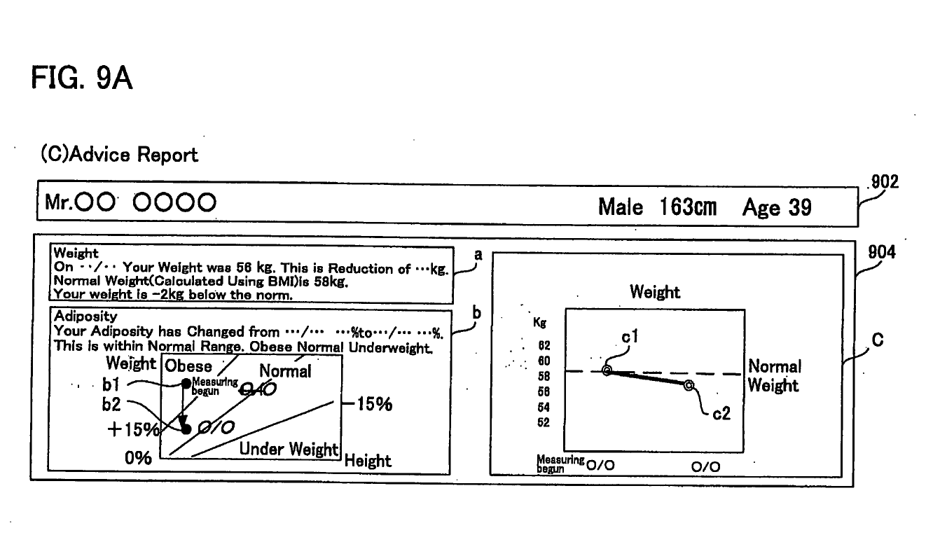

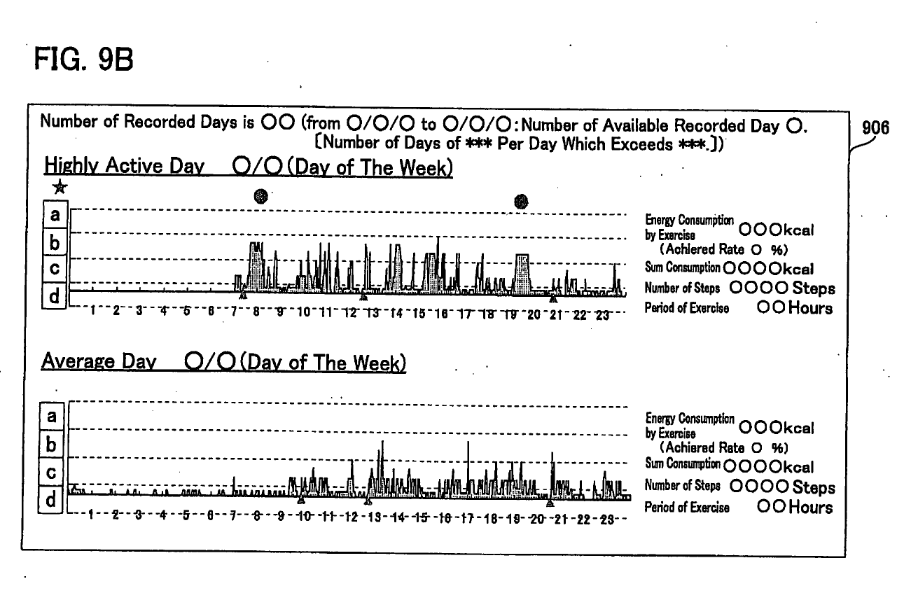

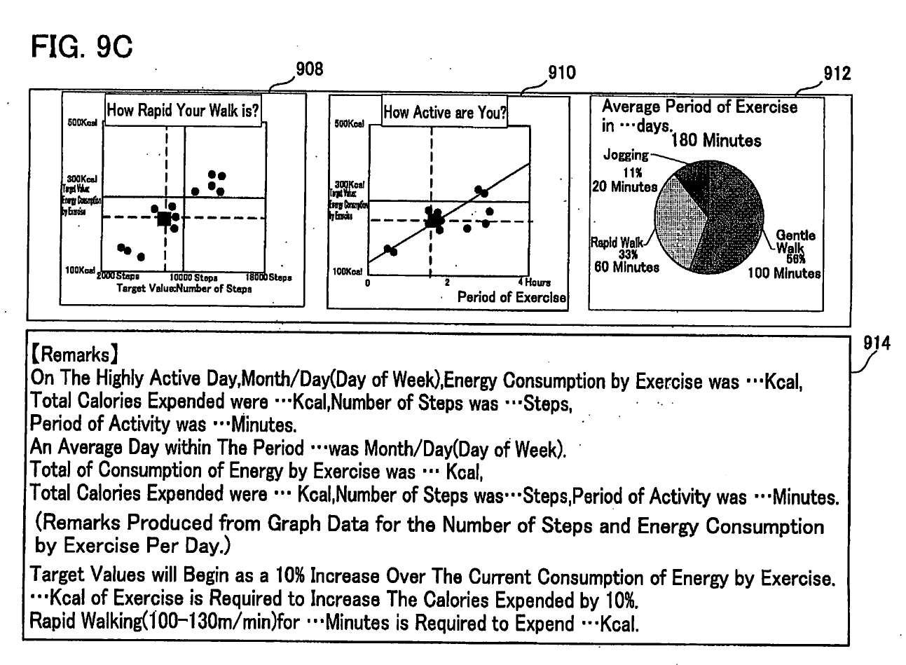

FIGS. 9A, 9B, and FIG. 9C are sample displays of the health management report using the ‘advice report format’ (C).

904 of FIG. 9A shows items relating to (1) weight. In b, height is shown on the horizontal axis, and weight is shown on the vertical axis. In b, upper and lower thresholds of the normal range are set. These thresholds are based on normal weight calculated using the BMI. Weight is ranked into three ranks: ‘obese,’ ‘normal,’ and ‘underweight’ using the upper and lower thresholds of the normal range. In this graph, weight at the time when measuring began (b1) and weight at the time when measuring was completed (b2) are plotted using black spots. This shows which rank weight has changed into. In c, also, weight at the time when measuring began (c1) and weight at the time when measuring was completed (c2) are plotted using double circles. Changes in weight are thus shown more clearly. Since weight is an easily grasped indicator of improvement in health management, this can act as a great incentive to subsequent exercise.

906 of FIG. 9B shows the graphs of the day which had maximum value of ‘energy consumption by exercise’ and the day which had average value. These graphs have been extracted out of the graphs of 6 weeks (these were shown in 804 of FIG. 8). These graphs can be displayed by performing a display operation, such as clicking on the black circle which marks the ‘highly active days’, or the white circle which marks ‘average days’ (these circles were shown in the graph of 708 of the ‘sum report format’ (A) shown in FIG. 7A). Other days can be specified, as desired, and the graphs of these days can be displayed in the same manner. Further, where the ‘energy consumption by exercise’ is shown at the right edge of 906, the rate achieved relative to the target value is displayed as a percentage.

908 of FIG. 9C is a plot graph showing the relationship between (2) the ‘energy consumption by exercise,’ and (5) the ‘number of steps.’ The ‘number of steps’ is shown on the horizontal axis and the ‘energy consumption by exercise ’ is shown on the vertical axis. The target value for the ‘number of steps’ is shown by the solid line extending in the vertical direction. The target value for the ‘energy consumption by exercise’ is shown by the solid line extending in the horizontal direction. These two solid lines divide the graph into four regions: a region in which both the number of steps and the energy consumption by exercise are below the target value, a region in which the energy consumption by exercise exceeds the target value and the number of steps is below the target value, a region in which the energy consumption by exercise is below the target value and the number of steps exceeds the target value, and a region in which both the energy consumption by exercise and the number of steps exceed the target value. In the graph, values representing the ‘number of steps’ and the ‘energy consumption by exercise ’ for 1 day are plotted using the black points, and the average value of the 6 week period is plotted using the black square. The dotted line extending in the vertical direction shows the average value of the ‘number of steps,’ and the dotted line extending in the horizontal direction shows the average value of the ‘energy consumption by exercise.’ Using this graph, it is possible to grasp the ‘state of exercise’ (‘walking state,’ ‘rapid walking state,’ or ‘running state’) at the time that the ‘number of steps’ was counted. This makes the exercise tendencies of the subject apparent. Appropriate health management advice can thus be given to subjects who tend to perform low intensity exercise, or to subjects who tend to perform exercise with excessive intensity.

910 is a plot graph showing the relationship between (2) the ‘energy consumption by exercise,’ and (4) the ‘period of each state of activity’ (the period of exercise). The ‘period of exercise’ is shown on the horizontal axis and the ‘energy consumption by exercise’ is shown on the vertical axis. The target value for the ‘energy consumption by exercise’ is taken as the central part of the vertical axis, and is shown by a solid line extending in the horizontal direction. This solid line divides the graph into two regions: a region in which the energy consumption by exercise is below the target value, and a region in which the energy consumption by exercise exceeds the target value. The graph may also be divided into four regions, as with 908, such that the target value for the period of exercise is taken as the central part of the horizontal axis, and is shown by the solid line extending in the vertical direction. In the graph, values representing the ‘period of exercise’ and the ‘energy consumption by exercise’ for 1 day are plotted using black points, and the average value for the 6 week period is plotted using a black square. The dotted line extending in the vertical direction shows the average value of the ‘period of exercise,’ and the dotted line extending in the horizontal direction shows the average value of the ‘energy consumption by exercise.’ By using this graph, it is possible to understand the ‘state of exercise’ at the time that the ‘period of exercise’ was measured. Advice concerning appropriate exercise can be given. Further, subjects whose lifestyle tends to have insufficient ‘periods of activity’ (such as the elderly who tend to be house-bound) can also be given advice on appropriate living habits.

Furthermore, a linear regression line displayed in 910 shows the general trend of the values of the plotted black points. The exercise tendencies of the subject are clear from the slope of this linear regression line, and this makes it clear what advice must be given to the subject For example, when the linear regression line has a small slope, the subject has a tendency to exercise with a low ‘intensity of activity.’ The subject must be advised to increase the ‘intensity of activity’ of his/her exercise. These subjects (for whom the linear regression line has a small slope) include those who find it difficult to increase their ‘intensity of activity’ (such as the elderly). When this type of subject fails to reach the target value of ‘energy consumption by exercise,’ it is possible to consider the extent to which the ‘period of exercise’ should be increased. It is thus possible to give reasonable and effective health management advice. If, instead, the linear regression line has a large slope, the subject tends to engage in exercise with too high an ‘intensity of activity.’ The subject must be advised to perform exercise with a lower ‘intensity of activity’ and to perform this for a longer ‘period of exercise.’ Specific health management advice can thus be given in response to the slope of the linear regression line.

912 shows items concerning (4) the ‘period of each state of activity’ (the period of exercise). The average value for 1 day out of the 6 weeks is shown.

914 shows overall remarks on the data shown in 906 to 912, and remarks to be used in giving health management advice.

The present embodiment described above merely illustrates one example of the present invention, and the scope of the present invention is not restricted to the present embodiment described above. Those skilled in the art can embody the present invention in a variety of ways within the scope of the claims. For example, the present invention may also be embodied using the transformations and modifications described below.

In the present embodiment, the activity data measured by the measuring device is transmitted to the data processing device, and the data processing device produces the health management report using this activity data. However, it is also possible for the activity status data to be produced by the measuring device and to be transmitted to the data processing device, and for the data processing device to produce the health management report using this activity status data That is, the data (referred to as the activity data in the claims) transmitted to the data processing device from the measuring device may have any kind of data format, configuration or the like, as long as the intensity of activity of the subject can be specified.

In the present embodiment, the activity data was also processed within the measuring device. However, it is also possible that this processing is performed only in the data processing device.

In the present embodiment, the medical examination result database is external to the data processing device. However, it may also be provided within the data processing device.

In the present embodiment, the activity data stored within the measuring device is corrected when the timer of the measuring device is corrected (when data overlaps, one part of the data overwrites and the other part is deleted, or dummy data is inserted when there is a blank period). However, the present invention is not limited to this configuration. Uncorrected activity data may be transmitted from the measuring device to the data processing device, and the activity data may be corrected within the data processing device.

1. A health management system comprising:
a measuring device carried by a subject, the measuring device measuring activity of the subject,
a medical examination result database for storing medical examination result data history of the subject,
and a data processing device connected with the measuring device for mutual communication, the data processing device processing activity data obtained by the measuring device,
wherein the measuring device comprises means for measuring movement of the subject, means for storing the activity data showing intensity of activity of the subject, the intensity of activity having been determined from the measured movement of the subject, means for storing identification information specifying the subject, and means for transmitting the activity data stored in the activity data storing means and the identification information stored in the identification information storing means to the data processing device,
wherein the medical examination result database is connected with the data processing device for mutual communication, and stores the medical examination result data history of the subject which is correlated with the identification information of the subject, and
wherein the data processing device comprises means for receiving the activity data and the identification information transmitted from the transmitting means of the measuring device, and means for outputting a health management report, the health management report having been produced on the basis of the received activity data and on the basis of the medical examination result data history extracted from the medical examination result database, the medical examination result data history having been correlated with the received identification information.

2. A health management system as in claim 1, wherein the transmitting means of the measuring device transmits the activity data which has been stored within a predetermined period, and wherein the health management report output by the data processing device includes states of activity within the predetermined period, these states of activity having been calculated from the activity data, and the medical examination result data from before and after the predetermined period.

3. A health management system as in claim 2, wherein the medical examination result database stores weight data of the subject, and wherein the medical examination result data, which are shown on the health management report output by the data processing device, includes the weight data from before and after the predetermined period.

4. A health management system as in claim 3, wherein the medical examination result database further stores height data of the subject, and wherein the health management report output by the data processing device further includes a graph of weight and height, one of these weight and height being on a vertical axis and the other on a horizontal axis, the graph showing a boundary between an upper limit and a lower limit of normal weight range, the range having been set on the basis of the height data of the subject, and the graph also showing the weight data from before and after the predetermined period.

5. A health management system as in claim 1, wherein the identification information, which is stored in the identification information storing means of the measuring device, includes the information for specifying a group to which the subject belongs, wherein the medical examination result database stores the medical examination result data history of each subject belonging to the group, and wherein the health management report output by the data processing device includes an average value of the medical examination result data of the group which is specified from the identification information.

6. A health management system as in claim 1, wherein the data processing device further comprises means for inputting the identification information for specifying the subject, and means for transmitting the input identification information to the measuring device, and
wherein the measuring device further comprises means for receiving the transmitted identification information, and means for replacing the identification information, which is stored in the identification information storing means, with the received identification information.

7. A health management system as in claim 6, wherein the identification information, which is stored in the identification information storing means of the measuring device, is replaced with the received identification information only when the identification information receiving means has received this identification information from the data processing device.

8. A health management system as in claim 1, wherein the measuring device further comprises a first timer and means for producing a calendar date based on the time kept by the first timer,
wherein the data processing device further comprises a second timer, means for producing calendar data for correction, the calendar data being based on the time kept by the second timer, and means for transmitting the calendar data for correction to the measuring device, and
wherein the measuring device further comprises means for receiving the calendar data for correction, and means for correcting the first timer on the basis of the received calendar data for correction.

9. A health management system as in claim 8, wherein the measuring device further comprises means for inserting calendar data, which have been produced within each first predetermined period, into the activity data, the activity data being produced within each second predetermined period and being stored in the activity data storing means, and means for correcting the activity data stored in the activity data storing means, the activity data correcting means being performed on the basis of a period for producing activity data, the period being specified from the calendar data inserted into the activity data, and
wherein the activity data correcting means performs the following: in the case where a plurality of items of activity data are stored from overlapping periods for producing activity data, any one of these plurality of items of activity data is retained and the other items are deleted, and in the case where the activity data has a blank period in which no activity data has been produced, dummy data is inserted into the blank period.

10. A data processing device connected with the measuring device for measuring activity of a subject for mutual communication, the data processing device processing the activity data transmitted from the measuring device, the data processing device comprising:
means for receiving the activity data transmitted from the measuring device, and
means for outputting a health management report including states of activity calculated from the received activity data,
wherein a period in which the received activity data was obtained is divided into a plurality of first determined periods, and wherein the health management report includes a graph displaying, for each first predetermined period, an total of time, the total of time having been obtained from the activity data for the case where intensity of activity was above a predetermined value during the first predetermined period, and the graph indicating the total of time within a plurality of first predetermined periods with a marker, the total of time having exceeded the predetermined total of time.

11. A data processing device as in claim 10, further comprising:
a display for displaying the health management report,
means for selecting one of the totals of time displayed in the display, and
means for displaying changes over time in the activity data in the display after one of the totals of time has been selected by using the selecting means, the activity data being obtained within the first determined period of the selected total of time.

12-23. (canceled)

24. A measuring device carried by a subject and measuring activity of the subject, comprising:
means for measuring movement of the subject,
means for storing activity data, the activity data showing intensity of activity of the subject, the intensity of activity having been determined from the measured movement of the subject,
means for producing display data for displaying changes over time in the activity data stored in the activity data storing means, and
a display for displaying the changes over time in the activity data based on the display data, wherein, in the display, a predetermined threshold value which has been set for intensity of activity functions as a boundary, and a background color in the case where the intensity of activity is below the threshold value differs from a background color in the case where the intensity of activity exceeds the threshold value.

25. A measuring device as in claim 24, wherein, in the display, the background color in the case where the intensity of activity is below the threshold value is the same color as the background color in the case where the intensity of activity exceeds the threshold value, but the background color is lighter and darker shades of the same color.

26. A measuring device as in claim 25, wherein the measuring device comprises means for inputting a beginning point of the display of changes over time in the activity data, wherein, in the display, the changes over time in the activity data within a predetermined period are displayed from this input beginning point.

27. A data processing device as in claim 10, wherein a period in which the received activity data was obtained is divided into a plurality of second predetermined periods, and wherein the health management report includes a graph displaying, for each second period, the energy consumption or the number of steps, these having been calculated from the activity data obtained within the second determined period, and background colors of the graph differ on one side and the other side of the boundary, the boundary functioning a determined value set for the energy consumption or the number of steps.

28. A data processing device as in claim 27, wherein a period in which the received activity data was obtained is divided into a plurality of third predetermined periods, and wherein the health management report includes a graph displaying, for each third predetermined period, changes over time in the activity data, and a graph displaying an total of time for each state of exercise, these total of time having been obtained by dividing the activity data obtained within the third predetermined periods into a plurality of states of exercise, these states of exercise having been set earlier to correspond to intensity of activity.

29. A data processing device as in claim 28, wherein a period in which the received activity data was obtained is divided into a plurality of fourth predetermined periods, and wherein the health management report includes a plot graph having plotted thereon one of ‘either period of exercise or number of steps’ and energy consumption, these having been calculated from the activity data of the fourth predetermined period, and one of ‘either period of exercise or number of steps’ and the energy consumption being on a vertical axis and the other on a horizontal axis.

30. A data processing device as in claim 10, further comprising means for deleting certain activity data from the received activity data, and for calculating a state of activity, the deleted activity data being: activity data wherein intensity of activity is outside a predetermined threshold range and is continued longer than a predetermined period, or activity data wherein a number of steps within a predetermined period is outside a predetermined threshold range, this number of steps having been calculated from the activity data.

31. A data processing device as in claim 10, further comprising:
means for accumulating and storing the received activity data,
means for inputting a period wherein state of activity of the subject is evaluated, and
means for calculating the state of activity of the subject from the activity data stored in the storing means, these activity data having been obtained within the input evaluating period,
wherein calendar data is inserted at a predetermined time into the activity data received by the receiving means, and wherein the calculating means specifies activity data occurring within the input evaluating period out of the activity data stored in the storing means, this specification being performed on the basis of the calendar data inserted into the activity data, and the calculating means calculates the state of activity from the specified activity data.
